(19) United States
(12) Patent Application Publication
(10) Pub. No.: US 2022/0029821 A1
(43) Pub. Date: Jan. 27, 2022

(54) OFFLOADING SIGNATURE GENERATION FOR API CALLS, AND APPLICATIONS THEREOF

(71) Applicant: Capital One Services, LLC, McLean, VA (US)

(72) Inventor: Alexander SCHOOF, Leesburg, VA (US)

(73) Assignee: Capital One Services, LLC, McLean, VA (US)

(21) Appl. No.: 16/934,824

(22) Filed: Jul. 21, 2020

(51) Int. Cl. H04L 9/32; H04L 29/06; H04L 9/14

(52) U.S. Cl. CPC H04L 9/3247; H04L 9/14; H04L 63/126; H04L 67/40

(57) ABSTRACT

The disclosed method, system, and apparatus are directed to offloading signature generation to avoid security risks, such as the ones described above. In an embodiment, an application library may receive an unsigned request (e.g., an unauthenticated API call) from an application. The unsigned request may include a target service (e.g., cloud computing resource) to which access is requested by the application. The application library may transmit the unsigned request to a signature generator. The signature generator may verify the unsigned request and generate a signature based on credential information accessible to the signature generator. The application library may receive the signature and may add the signature to the unsigned request to form a signed request (e.g., authenticated API call). The application library may transmit the signed request to the target service.

### BACKGROUND

Applications, including those executing in cloud computing environments, make Application Program Interface (API) calls to cloud computing resources to complete various tasks. An Application Program Interface (API) call is a request intended to be transmitted to an endpoint such as a cloud computing resource. The request instructs the cloud computing resource to performing a specified operation and return a result. A cloud computing resource is a service executing in a cloud computing environment. Examples of cloud computing resources are data storage devices, servers, computing resources or the like.

To authenticate these API calls and to prevent unauthorized access to the respective cloud computing resources, credentials are required. Cloud computing resources use the credentials to authenticate users so that only users that have authorization may access the cloud computing resource. For example, a cloud computing resource may be a data storage device. For security purposes, users with the appropriate credentials may access the data storage device as it may store sensitive information. Different types of credentials include usernames and passwords, biometric credentials (e.g., fingerprints, retina scans, or the like), passcodes, or the like.

Conventionally, an access management service, such as IAM Roles developed by AMAZON of Seattle, Wash., provisions credentials to an application attempting to make an API call. The access management service stores the credentials in a metadata service. A metadata service stores information about an instance (e.g., Elastic Cloud Computing (EC2) instance). EC2 is a service that allows business subscribers to run application programs in the computing environment. The metadata service also stores user data information for launching the instance. An example of a metadata service is Instance Metadata Service developed by AMAZON of Seattle, Wash.

Storing the credentials in a metadata service creates a security risk. This is because applications have direct access to the access management service and metadata service. A user, or potential attacker, can use these applications to gain access to the credentials, which can provide the user with unauthorized access to the cloud computing resources. In this way, the cloud computing resources can be compromised.

### BRIEF DESCRIPTION OF THE FIGURES

The accompanying drawings, which are incorporated herein and form part of the specification, illustrate the present disclosure and, together with the description, further serve to explain the principles of the disclosure and enable a person skilled in the relevant art to make and use the disclosure.

FIG. 1 is a block diagram illustrating a system for offloading signature generation.

FIG. 2 is a flowchart illustrating a process for offloading signature generation according to an example embodiment.

FIG. 3 is a flowchart illustrating a process for offloading signature generation according to an example embodiment.

FIG. 4 is a block diagram of an example environment in which systems and/or methods described herein may be implemented according to an example embodiment.

FIG. 5 is a block diagram of example components of a device according to some embodiments.

The drawing in which an element first appears is typically indicated by the leftmost digit or digits in the corresponding reference number. In the drawings, like reference numbers may indicate identical or functionally similar elements.

### DETAILED DESCRIPTION

Described herein is a method, system, and apparatus, or combinations and sub-combinations thereof for offloading signature generation.

As stated above, applications executing in a cloud computing environment make API calls to cloud computing resources for various purposes. Credentials are required to authenticate these API calls to prevent unauthorized access to the cloud computing resources. Conventionally, the credentials are stored in a metadata service. This configuration creates a security risk as any user with access to the metadata service can access the credentials and can access the cloud computing resources without the necessary authorization. In particular, applications executing in the cloud computing environment may have direct access to the metadata service storing the credentials. As an example, a hacker could access the metadata service using an application executing in the cloud computing environment and gain access to the credentials.

As an example, when using AMAZON Web Services (AWS) (provided by AMAZON of Seattle, Wash.), the credentials for accessing services in AWS may be stored in an Instance Metadata Service (IMDS). A software application executing on an AMAZON Elastic Cloud Computing (EC2) may need to access an AMAZON Simple Storage System (S3). The software application may make an API call including a request directed to S3. The AWS SDK may identify the name of the target service the software application is attempting to call (in this case, S3), the region of the target service the software application is attempting to call, a timestamp, and input parameters of the API call for executing the request. The services may reside in various geographic regions. The software application may be tied to a user account, which has access to services residing a given geographic region. The AWS SDK may access credentials for the service from the IMDS and generate a signature for the request. The AWS SDK may use an Identity and Access Management (IAM) role assigned to the EC2 instance to retrieve the credentials. The credentials may be used to generate the signature. For example, the credentials may be a username and password and the signature may be formed using the username and password. The signature proves that the request was made by an application that has access to a valid access key/secret key pair. The AWS SDK bundles the signature with the request and transmits the request to the target service (S3).

This configuration provides the software application executing on the EC2 instance with access to IMDS. That means that an attacker who gains temporary access to an instance can access the credentials and continue to use them from outside the EC2 instance.

The disclosed method, system, and apparatus are directed to offloading signature generation to avoid security risks, such as the ones described above. In an embodiment, an application library may receive an unsigned request (e.g., an unauthenticated API call) from an application. The unsigned request may include a target service (e.g., cloud computing resource) to which access is requested by the application. The application library may transmit the unsigned request to a signature generator. The signature generator may verify the unsigned request and generate a signature based on credential information accessible to the signature generator. The application library may receive the signature and may add the signature to the unsigned request to form a signed request (e.g., authenticated API call). The application library may transmit the signed request to the target service. The credential information remains inaccessible to the application. That is, the application or application library may not have access to the signature generation process or credentials, when transmitting a request to the target service. This configuration prevents the application to have direct access or visibility to the credential information.

The disclosed method, system, and apparatus for offloading signature generation solves the technical problem of software applications having direct access to credential information by providing a separate service that accesses the credentials for forming an authenticated API call. By doing so, software applications can continue to make authenticated API calls to cloud computing resources without having visibility into the credentials necessary to authenticate the API calls.

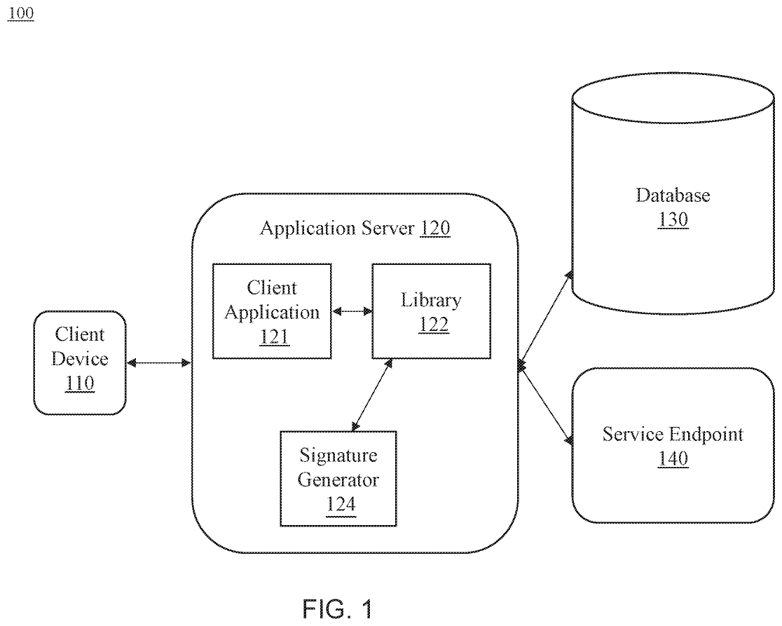

FIG. 1 is a block diagram illustrating a system for offloading signature generation. The system for offloading signature generation may include a client device 110, application server 120, database 130, and service endpoint 140. The application server 120 may include a client application 121, application library 122, and signature generator 124. Application server 120 may interface with the service endpoint 140 to transmit requests to various services (e.g., cloud computing resources). As a non-limiting example, the services may include database services, computing resources, hosting services, streaming services, on-demand software services, or the like. Signature generator 124 may be a daemon with access to the credentials for the various services. Each service may require credentials to access the service. Alternatively, each instance of a service may require credentials to access the instance of the service. The credentials may be stored in an instance profile in the database 130. The signature generator 124 may be configured to access the instance profile from the database 130. In one example, the signature generator 124 may receive the credentials at the execution of the service. Signature generator 124 may be developed in Python, Go, or Java.

Client device 110 may interface with application server 120 to execute client application 121. Client device 110 is a user device operated by a user to interface with the client application 121.

Client application 121 may generate an unsigned request that is intended to be transmitted to service endpoint 140. Client application 121 is a software application that is used by an end user for executing certain operations. As a non-limiting example, the client application 121 may be an internal Human Resources (HR) software application configured to manage employee data of a given company. The HR software application may interface with data storage devices in a cloud computing environment to manage employee data.

The unsigned request may be an API call to a given service for executing a given operation. The given service may require particular credentials to authenticate the request to execute the given operation. The request may include an identifier of the given service. Client application 121 may transmit the unsigned request to application library 122.

Application library 122 may transmit the request to signature generator 124. Application library 122 is an application that makes data and functions available to the client application 121. The application library 122 may be configured to interface with the service endpoint 140 as well as the client application 121. As an example, in the event the client application 121 is a python application calling an AWS service, the application library 122 may be a botocore library available from GitHub. A botocore library is configured to interface with AWS resources.

Signature generator 124 verifies the request and accesses the credentials for the particular service identified in the request. As an example, signature generator 124 may verify the request by verifying that client application 121 is residing on application server 120. In this regard, signature generator 124 may confirm that the request for the credentials is not coming from an application executing on an unidentifiable server. The credentials may include encryption keys including an access key and a secret key, particular to the given service.

Signature generator 124 may generate a signature with the credentials for the given service. The signature is generated based on the access key and the secret key of the given application. The access key may be a username and the secret key may be a password. As an example, the signature may be a hash value generated based on the access key and the secret key. Signature generator 124 may transmit the signature to application library 122. Application library 122 may receive the signature and may add the signature to the unsigned request to form a signed request (e.g., authenticated API call). The application library may transmit the signed request to the service endpoint 140. In an embodiment, the application library 122 may transmit the signed request to client application 121, and client application 121 may transmit the signed request to service endpoint 140. Client application 121 may not have access to signature generator 124. That is, the application and application library cannot access the encryption keys (e.g., credentials) for the services.

Service endpoint 140 may authenticate the request using the signature included in the request and execute the necessary operations. Service endpoint 140 may generate a response after completing the operation and transmit the response to application library 122. The application library may unpack the response and transform the response to a format accepted by the client application 121.

As a non-limiting example, the system described herein may be implemented using AMAZON Web Services (AWS) (developed by AMAZON). Client application 121 may be an executable software application (e.g., web-service) running on an AMAZON EC2 instance. Client application 121 may need to access an AMAZON Simple Storage Service (S3) and write data to the S3. Client application 121 may transmit a request to access S3 and write data to S3. The request may be an unauthenticated API call to S3. The request may include an identifier of S3 and the necessary operation to be performed (i.e., write data to S3).

The request may be transmitted to application library 122. Application library 122 may transmit the request to signature generator 124. Signature generator 124 retrieves the credentials for S3 and generates a signature for the request using the credentials. Signature generator 124 may transmit the signature to the application library 122. Application library 122 may format the request to include the signature in the request. In this regard, the request is transformed from an unauthenticated API call to an authenticated API call. Application library 122 may transmit the authenticated request (i.e., API call) to S3 (or service endpoint 140).

S3 may process the request and transmit a response to client application 121. Application library 122 may receive the response and may transform the response in a format acceptable by client application 121. Application library 122 may forward the transformed response to client application 121.

It can be appreciated that the disclosed system may be implemented in any cloud computing environment. For example, the disclosed system may be implemented on MICROSOFT AZURE (developed by MICROSOFT), GOOGLE Cloud Platform (developed by GOOGLE), VMWARE (developed by VMWARE), IBM Cloud (developed by IBM), or the like.

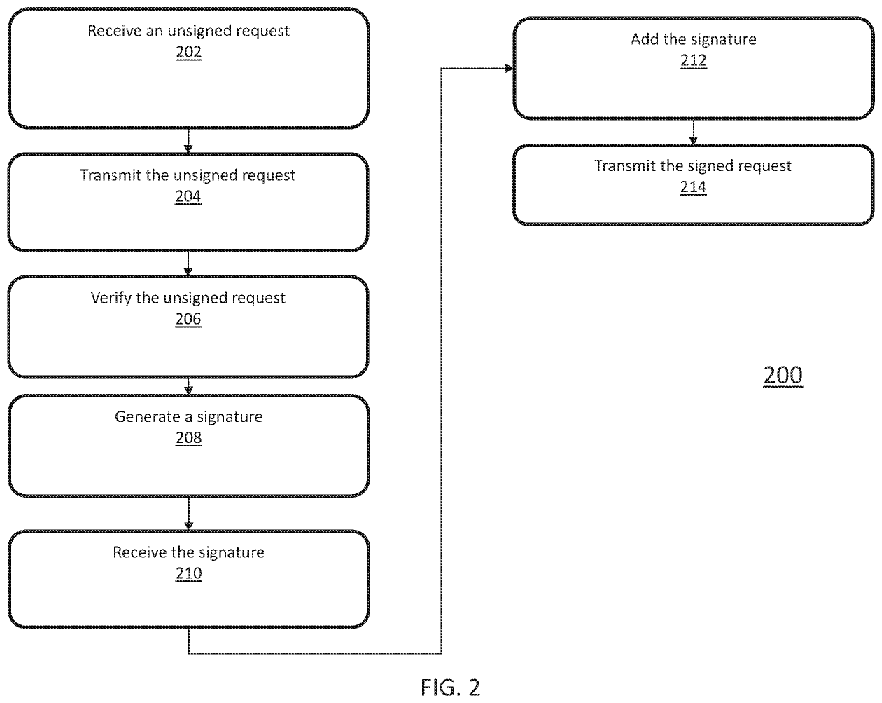

FIG. 2 is a flowchart illustrating a process for offloading signature generation according to an example embodiment.

In operation 202, an application library may receive an unsigned request from an application. The unsigned request includes a target service to which access is requested by the application. The application may be a client application and both the client application and application library may reside on an application server. The unsigned request may be an unauthenticated API call directed to the target service such as a cloud computing resource for completing the desired operation. The target service may require credentials to process the request.

In operation 204, the application library may transmit the unsigned request to a signature generator. The signature generator may also reside on the application server. The signature generator may be an SDK that has access to credentials for the target service, necessary to generate a signature for the unsigned request. The credential information is inaccessible to the application. That is, application does not have visibility into the credential information.

In operation 206, the signature generator may verify the unsigned request. The signature generator may verify the unsigned request by confirming the application library and application reside on the same application server as the signature generator. That is, the request is originated from the application server.

In operation 208, the signature generator may generate a signature based on credential information accessible to the signature generator. The credential information may an access key and a secret key for accessing the target service. The access key may be a username and the secret key may be a password. The signature may be a hash of the access key and secret key. The signature generator may transmit the signature to the application library.

In operation 210, the application library may receive the signature. The signature generator's tasks may be generating the signature while the application library may be responsible for generating a signed request using the signature. This creates an extra layer of security as the signature generator does not have access to the signed request and the application library does not have access to the signature generation process.

In operation 212, the application library may add the signature to the unsigned request to form a signed request. As an example, the application library may bundle up the request with the signature to form the signed request. The signed request may be an authenticated request (or API call) to the target service.

In operation 214, the application library may transmit the signed request to the target service. As described above, the application library may be configured to interface with the target service residing in a cloud computing environment as well as the client application. The application library may interface with the target service by transmitting the signed request to the target service.

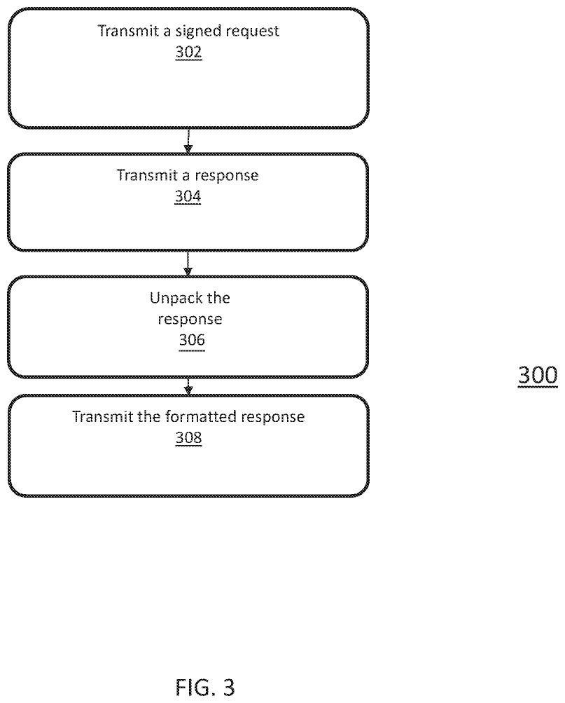

FIG. 3 is a flowchart 300 illustrating a process for receiving a response from a target service according to an example embodiment.

In operation 302, an application library may transmit a signed request to a target service. The target request may authenticate the request based on the signature included in the request and process the request. Processing the request may include performing desired operations included in the request.

In operation 304, the target service may transmit a response to the application server. The application server may include the application library, application, and signature generator. The response may include a result of the completed operations by the target services. As an example, the target service may be a data storage device. The request received by the target service may be for executing a commit on new data in the data storage device. In response to executing the commit, the target service may generate a response. The response may include a confirmation of executing the commit on the new data in the data storage device.

In operation 306, the application library may unpack the response and transform the response in a format accepted by the application. As described above, the application library may be configured to interface with the target service. The response may be in a format that is not readable by the client application. However, the application library may be able to read the response as it is able to interface with the target service. For this reason, the application library may format the response so that it is readable by the client application.

In operation 308, the application library may transmit the formatted response to the application. The formatted response may be presented by the application to a client device. Continuing with the earlier example, the response may be a confirmation that the commit was executed. The application may render the confirmation on a display of the client device.

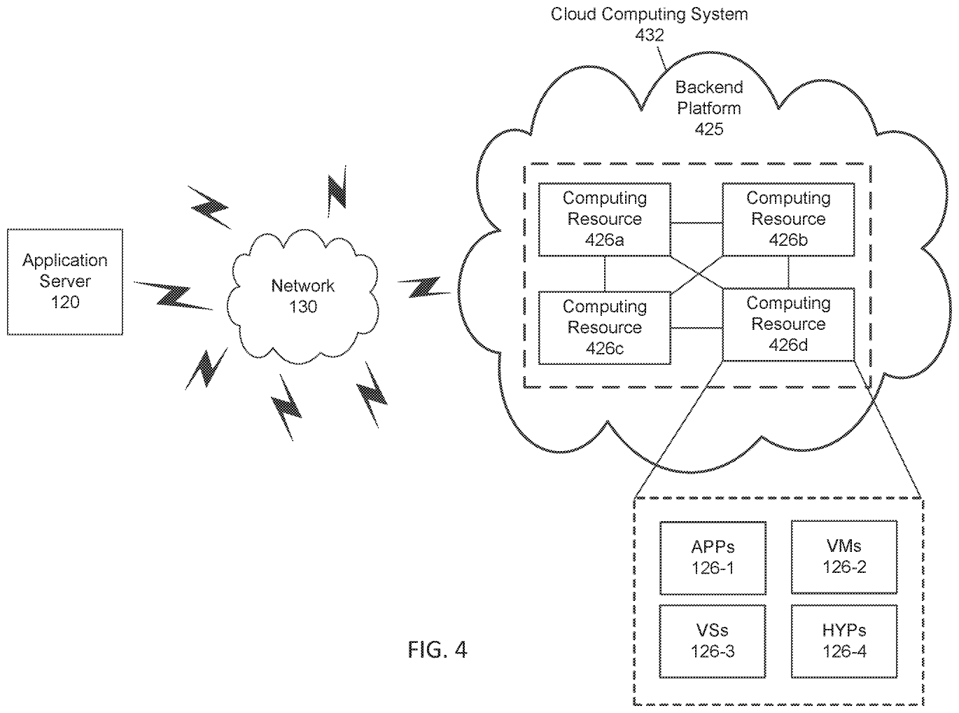

FIG. 4 is a block diagram of an example environment in which systems and/or methods described herein may be implemented according to an example embodiment. The environment application server 120, a backend platform 425, a cloud computing environment 432, and a network 430. The devices of the environment may be connected through wired connections, wireless connections, or a combination of wired and wireless connections.

In an example embodiment, one or more portions of the network 430 may be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

The backend platform 425 may include one or more devices configured to host applications such as a client application (e.g., client application 121 as shown in FIG. 1). The backend platform 425 may include a server or a group of servers. In an embodiment, the backend platform 425 may be hosted in a cloud computing environment 432. It may be appreciated that the backend platform 425 may not be cloud-based, or may be partially cloud-based.

As shown in FIG. 1, application server 120 may include a client application, application library, and a signature generator. Application server 120 may reside fully or partially in the cloud computing environment 432. Alternatively, application server 120 may reside outside the cloud computing environment 432.

The cloud computing environment 432 includes an environment that delivers computing as a service, whereby shared resources, services, etc. may be provided to the application server 120 and/or the backend platform 425. The cloud computing environment 432 may provide computation, software, data access, storage, and/or other services that do not require end-user knowledge of a physical location and configuration of a system and/or a device that delivers the services. The cloud computing system 432 may include computing resources 426a-d. The computing resources 426a-d may be target services or service endpoints (e.g., service endpoint 140 as shown in FIG. 1).

Each computing resource 426a-d includes one or more personal computers, workstations, computers, server devices, or other types of computation and/or communication devices. The computing resource(s) 426a-d may host the backend platform 425. The cloud resources may include compute instances executing in the computing resources 426a-d. The computing resources 426a-d may communicate with other computing resources 426a-d via wired connections, wireless connections, or a combination of wired or wireless connections.

Computing resources 426a-d may include a group of cloud resources, such as one or more applications (“APPs”) 426-1, one or more virtual machines (“VMs”) 426-2, virtualized storage (“VS”) 426-3, and one or more hypervisors (“HYPs”) 426-4.

Application 426-1 may include one or more software applications that may be provided to or accessed by the application server 120. For example, applications 426-1 may be target services. The client application residing on the application server 120 may call these target services to perform various operations. Alternatively, the application 426-1 may eliminate a need to install and execute software applications on the application server 120. The application 426-1 may include software associated with backend platform 125 and/or any other software configured to be provided across the cloud computing environment 432. The application 426-1 may send/receive information from one or more other applications 426-1, via the virtual machine 426-2.

Virtual machine 426-2 may include a software implementation of a machine (e.g., a computer) that executes programs like a physical machine. Virtual machine 426-2 may be either a system virtual machine or a process virtual machine, depending upon the use and degree of correspondence to any real machine by virtual machine 426-2. A system virtual machine may provide a complete system platform that supports the execution of a complete operating system (OS). A process virtual machine may execute a single program and may support a single process. The virtual machine 426-2 may execute on behalf of a user and/or on behalf of one or more other backend platforms 425 and may manage the infrastructure of cloud computing environment 432, such as data management, synchronization, or long-duration data transfers.

Virtualized storage 426-3 may include one or more storage systems and/or one or more devices that use virtualization techniques within the storage systems or devices of computing resource 426a-d. With respect to a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how administrators manage storage for end users. File virtualization may eliminate dependencies between data accessed at a file-level and location where files are physically stored. This may enable optimization of storage use, server consolidation, and/or performance of non-disruptive file migrations.

Hypervisor 426-4 may provide hardware virtualization techniques that allow multiple operations systems (e.g., “guest operating systems”) to execute concurrently on a host computer, such as computing resource 426a-d. Hypervisor 426-4 may present a virtual operating platform to the guest operating systems and may manage the execution of the guest operating systems multiple instances of a variety of operating systems and may share virtualized hardware resources.

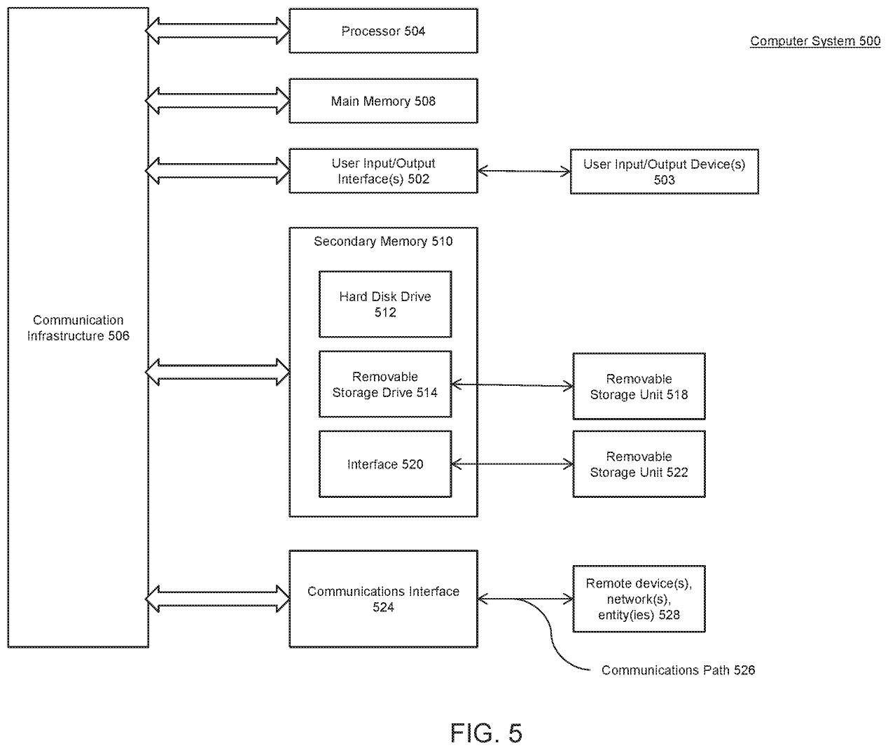

FIG. 5 is a block diagram of example components of device 500. One or more computer systems 500 may be used, for example, to implement any of the embodiments discussed herein, as well as combinations and sub-combinations thereof. Computer system 500 may include one or more processors (also called central processing units, or CPUs), such as a processor 504. Processor 504 may be connected to a communication infrastructure or bus 506.

Computer system 500 may also include user input/output device(s) 503, such as monitors, keyboards, pointing devices, etc., which may communicate with communication infrastructure 506 through user input/output interface(s) 502.

One or more processors 504 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 may also include a main or primary memory 508, such as random access memory (RAM). Main memory 508 may include one or more levels of cache. Main memory 508 may have stored therein control logic (i.e., computer software) and/or data.

Computer system 500 may also include one or more secondary storage devices or memory 510. Secondary memory 510 may include, for example, a hard disk drive 512 and/or a removable storage device or drive 514.

Removable storage drive 514 may interact with a removable storage unit 518. Removable storage unit 518 may include a computer-usable or readable storage device having stored thereon computer software (control logic) and/or data. Removable storage unit 518 may be program cartridge and cartridge interface (such as that found in video game devices), a removable memory chip (such as an EPROM or PROM) and associated socket, a memory stick and USB port, a memory card and associated memory card slot, and/or any other removable storage unit and associated interface. Removable storage drive 514 may read from and/or write to removable storage unit 518.

Secondary memory 510 may include other means, devices, components, instrumentalities or other approaches for allowing computer programs and/or other instructions and/or data to be accessed by computer system 500. Such means, devices, components, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 may further include a communication or network interface 524. Communication interface 524 may enable computer system 500 to communicate and interact with any combination of external devices, external networks, external entities, etc. (individually and collectively referenced by reference number 528). For example, communication interface 524 may allow computer system 500 to communicate with external or remote devices 528 over communications path 526, which may be wired and/or wireless (or a combination thereof), and which may include any combination of LANs, WANs, the Internet, etc. Control logic and/or data may be transmitted to and from computer system 500 via communication path 526.

Computer system 500 may also be any of a personal digital assistant (PDA), desktop workstation, laptop or notebook computer, netbook, tablet, smartphone, smartwatch or other wearables, appliance, part of the Internet-of-Things, and/or embedded system, to name a few non-limiting examples, or any combination thereof.

Computer system 500 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 500 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), may cause such data processing devices to operate as described herein.

The present disclosure has been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

The foregoing description of the specific embodiments will so fully reveal the general nature of the disclosure that others may, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments but should be defined only in accordance with the following claims and their equivalents.

What is claimed is:

1. A computer-implemented method for offloading signature generation, the method comprising:
receiving, by an application library, an unsigned request from an application, wherein the unsigned request includes a target service to which access is requested by the application;
transmitting, by the application library to a signature generator, the unsigned request;
verifying, by the signature generator, the unsigned request;
generating, by the signature generator and responsive to the verifying, a signature based on credential information accessible to the signature generator;
receiving, by the application library, the signature;
adding, by the application library, the signature to the unsigned request to form a signed request; and
transmitting, by the application library, the signed request to the target service,
wherein the credential information is inaccessible to the application.

2. The method of claim 1, wherein verifying the unsigned request comprises determining whether the application is installed on the server.

3. The method of claim 1, wherein the credential information comprises a plurality of encryption keys including an access key and a secret key.

4. The method of claim 3, wherein the application and the application library are prevented access to the plurality of encryption keys.

5. The method of claim 3, wherein the signature is generated based on the access key and the secret key.

6. The method of claim 5, wherein the signature is a hash of the access key and the secret key.

7. The method of claim 3, wherein the application library is prevented from generating a signature based on the plurality of encryption keys.

8. A non-transitory computer-readable medium storing instructions, the instructions, when executed by a processor, cause the processor to perform operations comprising:
receiving, by an application library, an unsigned request from an application, wherein the unsigned request includes a target service to which access is requested by the application;
transmitting, by the application library to a signature generator, the unsigned request;
verifying, by the signature generator, the unsigned request;
generating, by the signature generator and responsive to the verifying, a signature based on credential information accessible to the signature generator;
receiving, by the application library, the signature;
adding, by the application library, the signature to the unsigned request to form a signed request; and
transmitting, by the application library, the signed request to the target service,
wherein the credential information is inaccessible to the application.

9. The non-transitory computer-readable medium of claim 8, wherein verifying the unsigned request comprises determining whether the application is installed on a server.

10. The non-transitory computer-readable medium of claim 8, wherein the credential information comprises a plurality of encryption keys including an access key and a secret key.

11. The non-transitory computer-readable medium of claim 10, wherein the application and the application library are prevented access to the plurality of encryption keys.

12. The non-transitory computer-readable medium of claim 10, wherein the signature is generated based on the access key and the secret key.

13. The non-transitory computer-readable medium of claim 11, wherein the signature is a hash of the access key and the secret key.

14. The non-transitory computer-readable medium of claim 10, wherein the application library is prevented from generating a signature based on the plurality of encryption keys.

15. An apparatus for storing at least one file using a physical object displayed on a mobile device, comprising:
a memory; and
a processor communicatively coupled to the memory and configured to:
receive, by an application library, an unsigned request from an application, wherein the unsigned request includes a target service to which access is requested by the application;
transmit, by the application library to a signature generator, the unsigned request;
verify, by the signature generator, the unsigned request;
generate, by the signature generator and responsive to the verifying, a signature based on credential information accessible to the signature generator;
receive, by the application library, the signature;
add, by the application library, the signature to the unsigned request to form a signed request; and
transmit, by the application library, the signed request to the target service,
wherein the credential information is inaccessible to the application.

16. The apparatus of claim 15, wherein the credential information comprises a plurality of encryption keys including an access key and a secret key.

17. The apparatus of claim 16, wherein the application and the application library are prevented access to the plurality of encryption keys.

18. The apparatus of claim 16, wherein the signature is generated based on the access key and the secret key.

19. The apparatus of claim 18, wherein the signature is a hash of the access key and the secret key.

20. The apparatus of claim 16, wherein the application library is prevented from generating a signature based on the plurality of encryption keys.
